(19) United States
(12) Patent Application Publication
(10) Pub. No.: US 2005/0081446 A1
(43) Pub. Date: Apr. 21, 2005

(54) Adjustable security apparatus for protection of door and window openings

(76) Inventor: Mauro Muller, San Diego, CA (US)

Correspondence Address: SUGHRUE MION, PLLC, 2100 PENNSYLVANIA AVENUE, N.W., SUITE 800, WASHINGTON, DC, 20037, US

(21) Appl. No.: 10/986,226

(22) Filed: Nov. 12, 2004

Related U.S. Application Data
(62) Division of application No. 10/143,977, filed on May 14, 2002.

(51) Int. Cl. E06B 7/00

(52) U.S. Cl. 49/57

(57) ABSTRACT

An adjustable apparatus for protection of a door or window opening having an upper frame and a lower frame, the adjustable apparatus including a plurality of posts, a first end plate for fastening a first end of the adjustable apparatus to the upper frame of the opening, and a second end plate for fastening a second end of the apparatus to the lower frame of the opening, wherein the plurality of posts further include a first portion having a predetermined length and a second portion having a predetermined length, wherein the first portion telescopically engages the second portion, and wherein a length of the plurality of posts telescopically adjusts to correspond to a longitudinal dimension between the upper frame and the lower frame of the opening.

### BACKGROUND OF THE INVENTION

The present invention relates to an apparatus for the protection of door and window openings; more particularly, to an improved adjustable security apparatus for the protection of door and window openings; and even more particularly, to an improved security apparatus for the protection of door and window openings that is capable of extending telescopically to adjust to any door or window size.

In the construction of residential and commercial homes and buildings, openings for doors and windows are framed in the building structure. Next, door and window fixtures are installed in these framed openings. If security is required and the door or window itself does not already include its own security protection, a grill or similar protection device will be installed in the door or window opening. These conventional grills or similar protection devices must be manufactured according to the specific size of the door and window openings in which they will be installed, resulting in increased costs and longer delivery lead times. In addition, these structures cannot be removed and installed in different door or window openings without modification, unless the new door or window opening is the same size.

Several conventional security structures have attempted to solve some of these problems. For example, U.S. Pat. No. 5,492,164 (Gist) discloses a folding structure which extends across the window width and is secured to opposing guide elements. This system has a cover that is attached to the lower sash of the window. Several horizontal blocking rods are positioned under the cover. Each end of the horizontal blocking rods is positioned in the opposing guide elements. As the window is raised, the cover rises with it, followed by several horizontal blocking rods, which are lifted upwards in the guide elements. The blocking rods are positioned laterally across the opening of the window and are designed to prevent egress of children and pets through the open window. When the window is closed, the blocking rods are retracted and covered by the cover at the base of the window. However, because the rods retract, this system does not provide any security or protection when the window is closed. In addition, this system only protects the opening below the window when the window is in an open position. It does not protect the entire window area neither when the window is in the open position nor the closed position. Further, this system is not applicable to both doors and windows.

U.S. Pat. No. 649,136 (Mockel) is another example of the conventional security apparatus. Mockel also relates to a guard adapted to prevent children or inanimate objects from falling out of a window. The guard is composed of a pair of uprights and a plurality of horizontal connecting bars or bands pivotal about points on one of the uprights so that they may be folded up along one side of the window. However, Mockel, as with Gist, only protects the lower portion of the window using horizontal bars.

U.S. Pat. No. 5,910,076 (Gladney) discloses another conventional apparatus for security of doors and windows employing a security grill having an extending left section and right section. The left section includes a left vertical support member, a plurality of lateral support members, and the plurality of vertical bars attached to and supported by the lateral support members. In addition, Gladney discloses a plurality of intermediate lateral extension members that are each inserted into a corresponding pair of left and right tubular lateral support members and are slidable therein to allow the horizontal extension of the left security grill section with respect to the right security grill section. However, Gladney does not permit vertical adjustability.

Another example of the conventional security apparatus is shown in U.S. Pat. No. 5,943,832 (Russell). Russell discloses a flood or storm resistant barrier for a doorway or window opening. The barrier is formed of a frame having two parts with one part in telescopic engagement with the other frame part. In addition, Russell discloses a manually operable jack in the form of four links that are pivotally connected to form a parallelogram linkage which is inserted between the two frame parts. The jack is operated to move the frame parts laterally relative to one another so as to vary the horizontal dimensions of the frame and enable the frame to be secured across the horizontal dimension of the doorway or window opening. A waterproof barrier member is carried by the frame for blocking the portion of the doorway or window opening. However, as with the other conventional apparatus, Russell does not permit vertical-adjustability.

In yet another example of the conventional security apparatus, U.S. Pat. No. 5,916,074 (Tracy) discloses a window guard for mounting in or on a window to protect children and objects from falling out of the window. A first wire subassembly and a second wire subassembly are interconnected along side of each other by metal clamps that allow each subassembly to slide with respect to the other subassembly and thereby allow the window guard to fit many different sized horizontal openings. Tracy also does not permit vertical adjustability.

As described above, the conventional security apparatus lack versatility and are limited in their application because they are limited to specific door or window sizes. Moreover, the conventional security apparatus are not easily adjustable to cover the entire window or door openings. In addition, the conventional security apparatus are not adjustable both vertically and horizontally. Furthermore, these conventional security apparatus are not easily installed, removed, and reinstalled. The conventional security apparatus doe not permit universal installation and application from one location to another location, which has a different size. It is therefore desirable to have a security apparatus for protection of door and window openings that is capable of extending telescopically to easily adjust to any door or window size to provide protection of the entire door or window area.

### SUMMARY OF THE INVENTION

It is therefore an aspect of the present invention to provide an adjustable security apparatus for protection of door and window openings.

It is another aspect of the present invention to provide an adjustable security apparatus for the protection of door and window openings that is capable of extending telescopically in a longitudinal direction to adjust to any door or window size.

It is a further aspect of the present invention to provide an adjustable security apparatus for protection of door and window openings that can be easily installed or removed from an existing door or window frame opening.

It is yet another aspect of the present invention to provide an adjustable security apparatus for protection of door and window openings that can be easily and efficiently installed, removed, and reinstalled in a different window frame or opening by vertically extending the adjustable security apparatus telescopically.

It is still another aspect of the present invention to provide a modular adjustable security apparatus for protection of door and window openings that can be installed, along with a plurality of similar modular adjustable security apparatus, in order to provide security over the entire area of a door or window opening.

It is yet another aspect of the present invention to provide an adjustable security apparatus for doors and windows that is constructed of a minimal number of parts, that is easily installed, removed, and reinstalled in a variety of door and window openings either temporarily or permanently, and that maintains an aesthetically pleasing appearance that does not detract or distract from its surroundings.

It is a further aspect of the invention to provide an adjustable security apparatus that minimizes the obstruction of a persons view through a window or door opening.

Further aspects, features and advantages of the invention may become apparent from the consideration of the following description and the appended claims when taken in connection with the accompanying drawings.

### BRIEF DESCRIPTION OF THE DRAWINGS

The above aspects and advantages of the present invention will become more apparent by describing in detail illustrative, non-limiting embodiments thereof with reference to the attached drawings, in which:

FIG. 1 is a side view depicting an adjustable security apparatus for protection of door and window openings, according to an illustrative, non-limiting embodiment of the present invention.

FIG. 2 is an exploded view of an adjustable security apparatus for protection of door and window openings, according to an illustrative, non-limiting embodiment of the present invention.

FIG. 3A-3C are perspective views of an adjustable security apparatus for protection of door and window openings, according to yet another illustrative, non-limiting embodiment of the present invention.

FIGS. 4A-4C are side views of an adjustable security apparatus for protection of door and window openings, according to an illustrative, non-limiting embodiment of the present invention.

FIGS. 5A and 5B are side views of an adjustable security apparatus for protection of door and window openings, according to an illustrative, non-limiting embodiment of the present invention.

FIGS. 6A-6C are perspective views of an adjustable security apparatus for protection of door and window openings, according to another illustrative, non-limiting embodiment of the present invention.

FIG. 7 is a perspective view depicting a means for fixing the adjustable security apparatus according to an illustrative, non-limiting embodiment of the present invention.

FIGS. 8A-8C are perspective views depicting an adjustable security apparatus for protection of door and window openings further comprising a reinforcement member, according to yet another illustrative, non-limiting embodiment of the present invention.

FIG. 9 is a perspective view depicting an adjustable security apparatus for protection of door and window openings installed on the exterior of a window frame, according to yet another illustrative, non-limiting embodiment of the present invention.

FIG. 10 is a perspective view depicting an adjustable security apparatus for protection of door and window openings installed on the interior of a window frame, according to still another illustrative, non-limiting embodiment of the present invention.

### DETAILED DESCRIPTION OF ILLUSTRATIVE EMBODIMENTS OF THE INVENTION

Hereinafter, illustrative, non-limiting embodiments of the present invention will be described in detail with reference to the attached drawings. The present invention is not restricted to the following illustrative embodiments, and many variations are possible within the spirit and scope of the present invention. Illustrative embodiments of the present invention are provided in order to more completely explain the present invention to one skilled in the art.

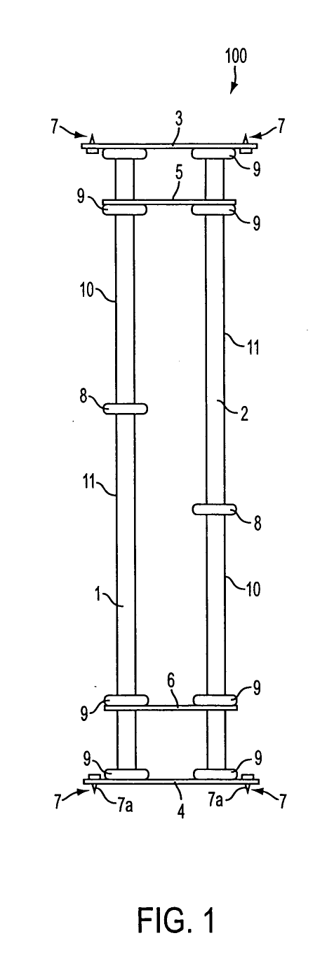

Illustrative embodiments of an improved adjustable security apparatus for protection of door and window openings that solves the aforementioned problems, and others, are now described with reference to FIGS. 1-9.

The present invention relates to an adjustable security apparatus for doors and windows that is capable of extending telescopically to adjust to any door or window size, and thereby, prevent access into the door or window.

As shown in FIG. 1, in an illustrative embodiment of the present invention, the adjustable security apparatus comprises an adjustable module 100. The module 100 preferably comprises, but is not limited to, at least two vertical posts 1, 2. Additional modules 100 can be installed adjacent to the first module in order to adequately protect the entire lateral area of the door or window opening.

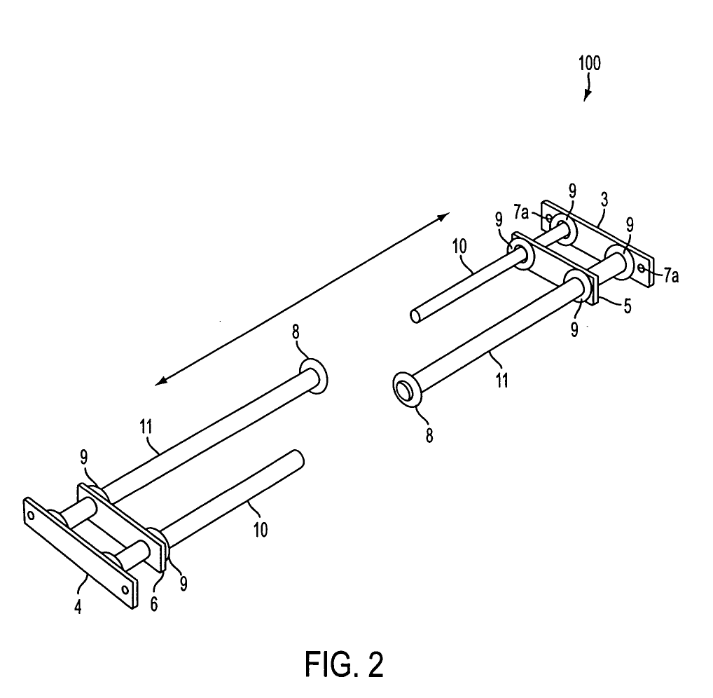

Specifically, with reference to FIGS. 1 and 2, the module 100 comprises two posts 1, 2. The posts 1, 2 are preferably, but not necessarily, substantially the same length. As shown in FIGS. 1 and 2, each post 1, 2, comprises a first portion 10 and a second portion 11. The first portion 10 is telescopically disposed within the second portion 11.

The second portion 11 has an inner diameter, or dimension, so that the second portion 11 can telescopically receive the first portion 10, which has a smaller outside diameter or dimension. Other embodiments can include posts 1, 2 that comprise greater than two portions. As shown in the illustrative embodiment depicted in FIG. 2, the first portion 10 and second portion 11 of post 1 are in a reverse orientation to the first portion 10 and second portion 11 of the post 2, so that the strength of the module is substantially the same at both ends. However, depending on the application, the orientation of the portions 10, 11 of posts 1, 2 is not required to be alternated.

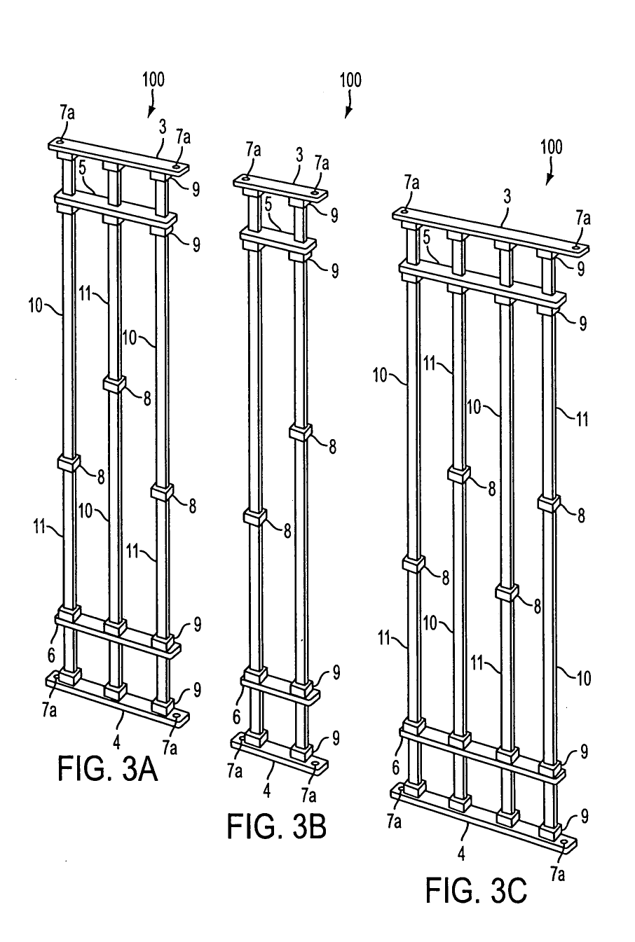

The posts 1, 2 depicted in FIG. 2 are tubular posts. However, the adjustable security apparatus can be formed from posts having various shapes. For example, the security apparatus can comprise posts that are square, round, oval, triangular, rectangular, hexagonal, or various other shapes. FIGS. 3A-3C depict posts 1, 2 having a rectangular or square shape, rather than a circular or tubular shape.

Preferably, but not necessarily, the shape of the first portion 10 should correspond to the second portion 11. However, in other illustrative embodiments, the shape of the first portion 10 and second portion 11 do not correspond. In these illustrative embodiments, it is possible to use different shapes so long as the second portion 11 is capable of accepting the first portion 10 in a telescopic manner; for example, a circular shaped first portion 10 that engages a square shaped second portion 11 in a telescopic manner.

Furthermore, the adjustable security apparatus can be formed from a variety of materials suited for this purpose. The module 100 can be formed from any material, or combination of materials, with suitable strength, such as, but not limited to, iron, steel, aluminum, plastics, composite materials, and so on.

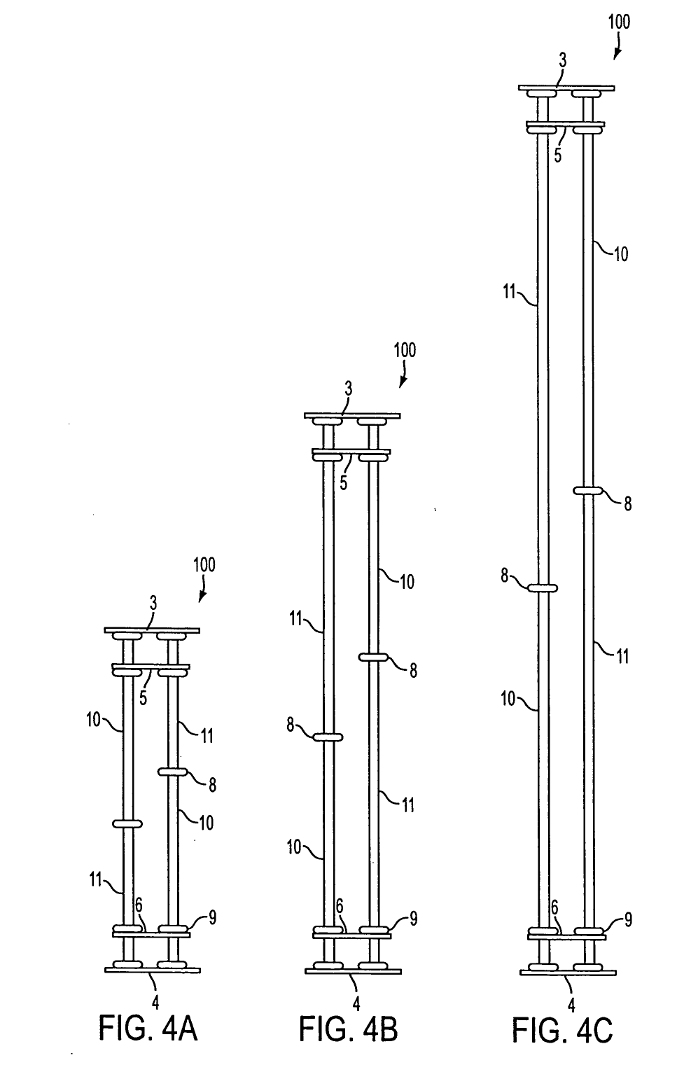

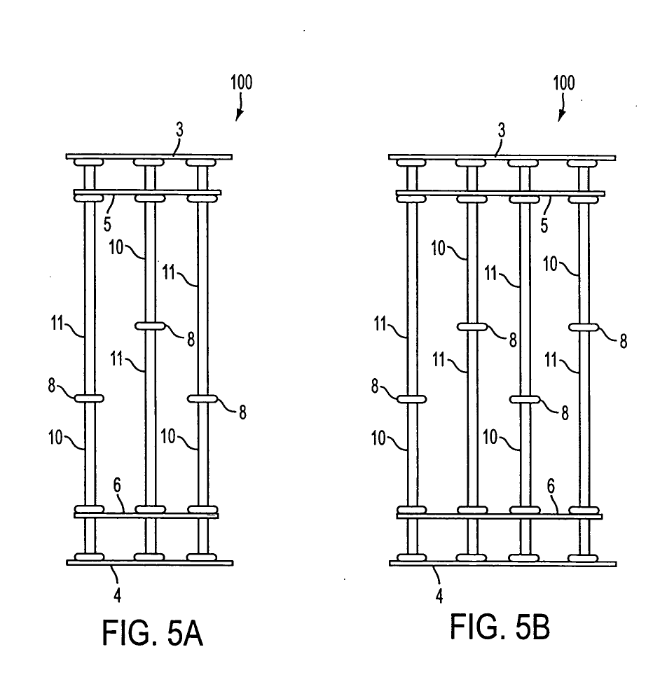

As shown in FIGS. 4A-4C, the first portion 10 and the second portion 11 are axially aligned and overlap one another so that they can be extended telescopically to fill an infinite variety of existing or newly constructed window or door opening sizes. FIGS. 4A-4C depicts other illustrative embodiments having various sizes of posts 1, 2. By simply increasing the length of posts 1, 2, the module can be applied to a wider range of door and window sizes. In addition, more than two posts may be employed such that one module can cover a larger area, as shown in FIGS. 3A, 3C, 5A, and 5B.

The module further comprises a first end plate 3 and a second end plate 4 fixed to either end of the module. The posts 1, 2 are fixed to the end plates 3, 4 so that post 1 is parallel to post 2.

As shown in the Figures, end plate 3 and end plate 4 are used to secure the module to the window or door frame. End plates 3 and 4 can include holes 7a for receiving a fastener 7, such as nail (shown), screw, or lag bolt, etc. Preferably, the fastener 7 is a security screw. Other fasteners 7 suitable for this purpose may also be used to secure the end plates 3 and 4 to the door or window frame.

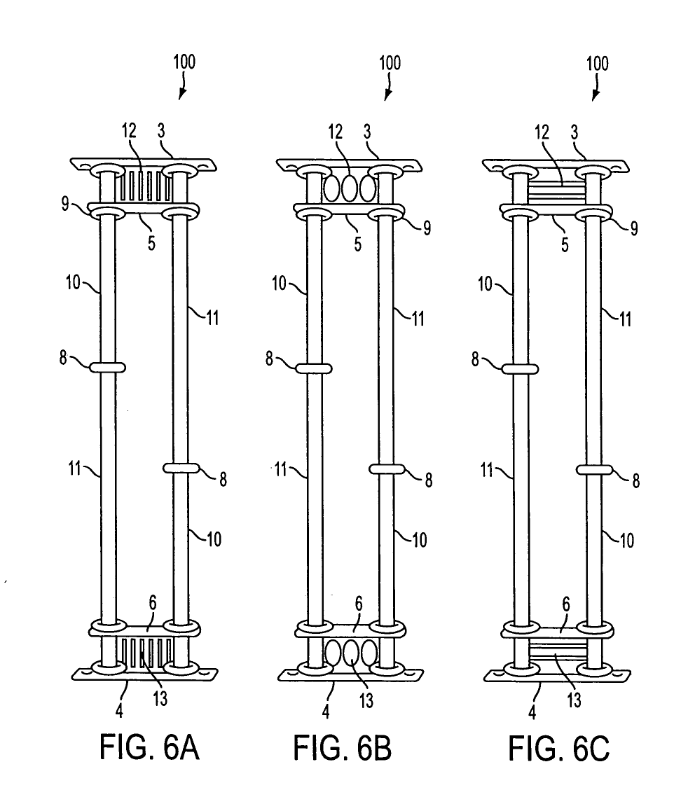

The module can also include a plurality of traversing bars 5, 6 that traverse the posts 1, 2 to provide added strength and rigidity to the module and to aid in maintaining the substantially parallel relationship between the post 1, 2. These traversing bars 5, 6 are preferably disposed towards the ends of the posts 1, 2. However, the traversing bars 5, 6 can also be positioned at various positions along the length of the posts 1, 2 depending on the application of the module 100. The traversing bars 5, 6 can be horizontal plates, as shown, for example, in FIGS. 1 and 2. In addition, the traversing bars 5, 6 can be used alone or in combination with vertical traversing plates 12, 13, as shown in FIG. 6A-6C. The vertical plate traversing bars 12,13 can comprise slits, holes, grooves, or webbing, etc., for reducing the weight of the vertical plate traversing bars 12, 13 while maintaining their strength and, additionally, improving the aesthetic appearance of the module. Further, additional transverse bars (not shown) may also be installed to provide added security and increased strength.

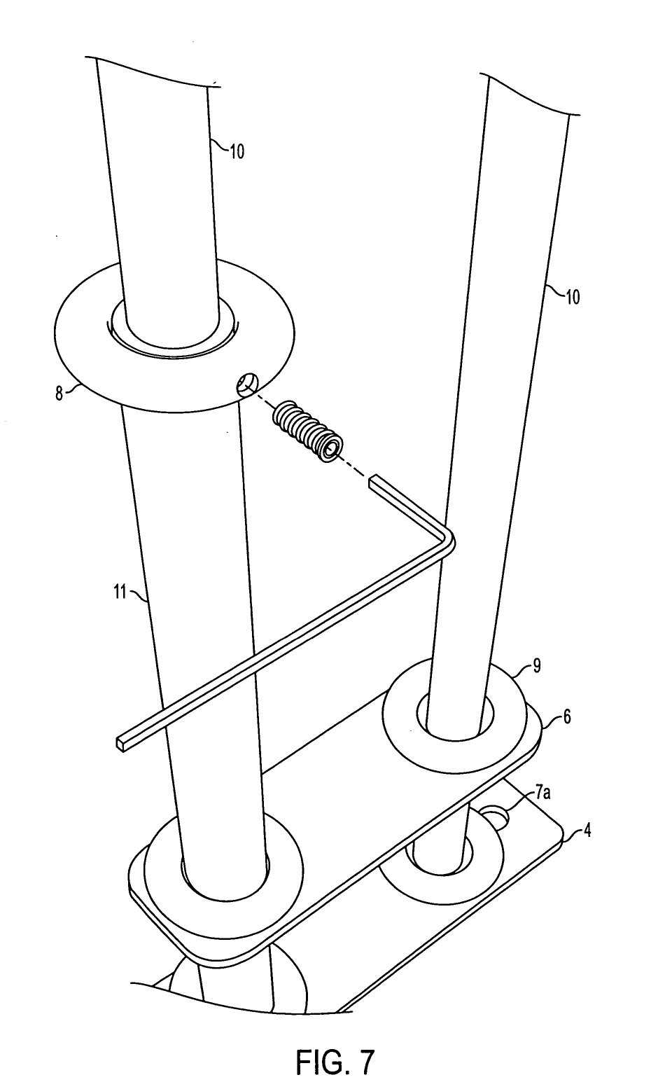

FIG. 7 depicts a coupling 8 which is used to secure the first portion 10 to the second portion 11 after the module has been extended and positioned within the window or door frame. As shown in FIG. 7, a non-limiting embodiment of the present invention uses a threaded hexagonal bolt than can be inserted using a standard hex wrench. In addition, other means for securing the first portion 10 to the second portion 11 are possible. For example, a key and lock can be used in conjunction with, or integrated in, the coupling 8 to secure the first portion 10 to the second portion 11. Clamps and other securing devices or fixing devices can also be used without departing from the scope of the present invention. Additional couplings 9, as shown in the Figures, can be used to secure the transverse plates to the posts or to provide added strength to the transverse plates 5, 6.

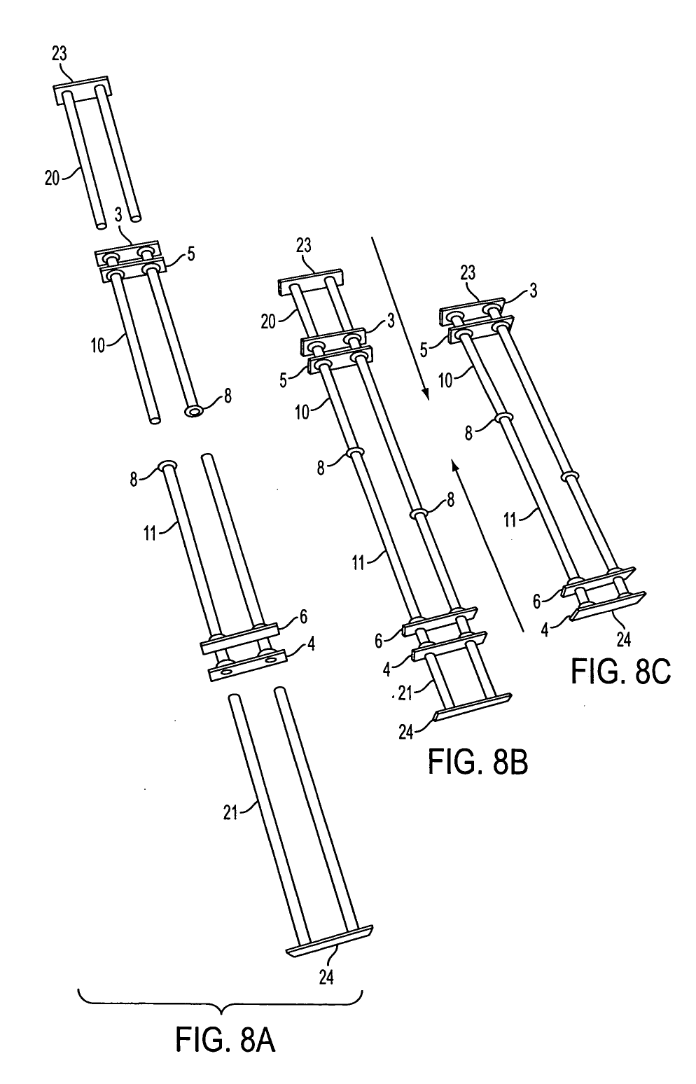

In another illustrative embodiment of the adjustable security apparatus depicted in FIG. 8A, the module comprises additional reinforcement members 20, 21 disposed within the first portion 10 and the second portion 11 for reinforcing the module. The additional reinforcing members 20, 21 can be either hollow or solid. In this embodiment, the first portion 10 and second portion 11 which form the exterior portions, are hollow so that they can receive the additional reinforcing members 20, 21 in a telescopic manner, as shown in FIGS. 8B and 8C. The exterior portions can be formed from any material, such as plastic, metal, or composite materials. Moreover, as a result of the additional reinforcement members 20, 21 in this embodiment, the exterior portions are not required to have a high strength or rigidity, and therefore, a larger variety of materials are suitable for the exterior portions. As with the other embodiments of the present invention, the hollow exterior portions and the reinforcing members 20, 21 can be formed in various cross-sectional shapes, for example, circular or rectangular, so long as the module is capable of telescopically extending.

Moreover, as shown in FIGS. 8A-8C, another illustrative embodiment includes additional reinforcement end plates 23, 24, either alone or in combination with the additional reinforcing members 20, 21. These reinforcement end plates 23, 24 can take the place of, or be disposed within the end plates 3, 4.

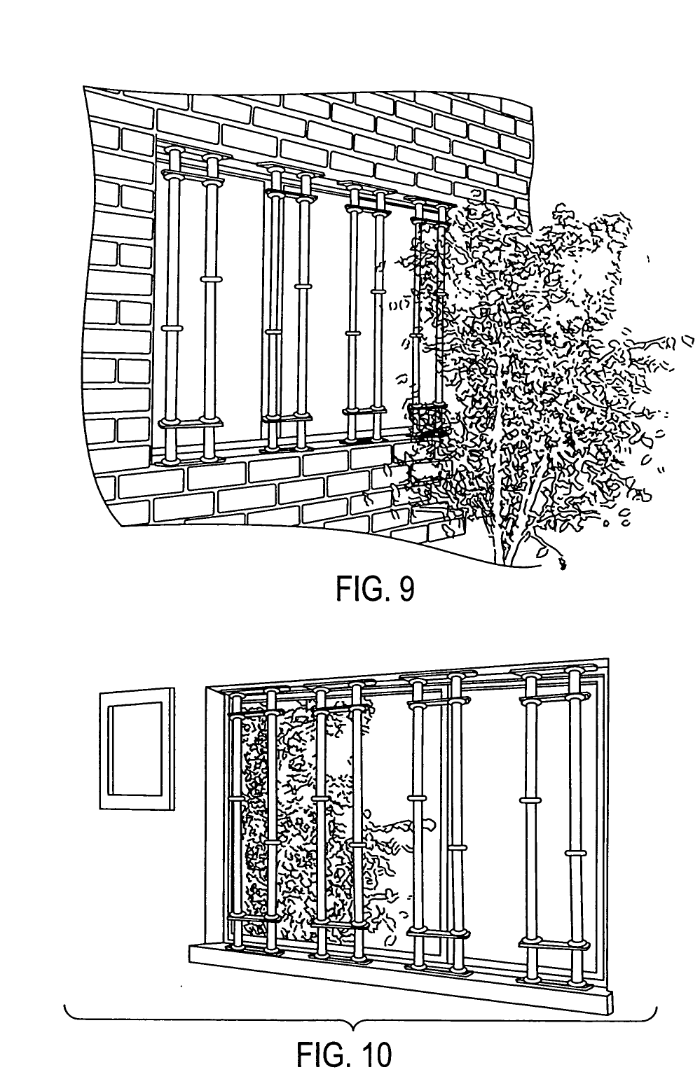

As shown in FIGS. 9 and 10, respectively, the above described illustrative embodiment of the adjustable security apparatus has the advantage that can it be installed inside or outside of the door or window. In addition, a plurality of modules 100 can be combined easily to span a wide range of door and window sizes. The telescopic vertical adjustability of the modules has the advantage of permitting easy application and adjustability to any size window or door opening. Furthermore, the modules 100 can also be installed in a horizontal position to provide increased flexibility and application to an even broader range of door and window opening sizes.

1-6. (canceled)

7. An adjustable apparatus for protection of a door or window opening having an upper frame and a lower frame, said adjustable apparatus comprising:
a plurality of posts;
a first end plate for fastening a first end of said adjustable apparatus to the upper frame of said opening; and
a second end plate for fastening a second end of said apparatus to the lower frame of said opening;
wherein said plurality of posts further comprise:
a first portion having a predetermined length; and
a second portion having a predetermined length;
wherein said first portion telescopically engages said second portion, and
wherein a length of said plurality of posts telescopically adjusts to correspond to a longitudinal dimension between said upper frame and said lower frame of said opening,
wherein said first portion and said second portion have a rectangular shape.

8. An adjustable apparatus for protection of a door or window opening having an upper frame and a lower frame, said adjustable apparatus comprising:
a plurality of posts;
a first end plate for fastening a first end of said adjustable apparatus to the upper frame of said opening; and
a second end plate for fastening a second end of said apparatus to the lower frame of said opening;
wherein said plurality of posts further comprise:
a first portion having a predetermined length; and
a second portion having a predetermined length;
wherein said first portion telescopically engages said second portion, and
wherein a length of said plurality of posts telescopically adjusts to correspond to a longitudinal dimension between said upper frame and said lower frame of said opening,
wherein said first portion and said second portion have a square shape.

9-11. (canceled)

12. An adjustable apparatus for protection of a door or window opening having an upper frame and a lower frame, said adjustable apparatus comprising:
a plurality of posts;
a first end plate for fastening a first end of said adjustable apparatus to the upper frame of said opening; and
a second end plate for fastening a second end of said apparatus to the lower frame of said opening;
wherein said plurality of posts further comprise:
a first portion having a predetermined length; and
a second portion having a predetermined length;
wherein said first portion telescopically engages said second portion, and
wherein a length of said plurality of posts telescopically adjusts to correspond to a longitudinal dimension between said upper frame and said lower frame of said opening,
further comprising at least one transverse member connecting said plurality of posts.

13. The adjustable apparatus according to claim 12, wherein said at least one transverse member is a horizontal plate.

14. The adjustable apparatus according to claim 12, wherein said at least one transverse member is a vertical plate.

15-17. (canceled)

18. The adjustable apparatus according to claim 23, further comprising at least one transverse member connecting said plurality of posts.

19. The adjustable apparatus according to claim 23, wherein said at least one transverse member is a horizontal plate.

20. The adjustable apparatus according to claim 23, wherein said at least one transverse member is a vertical plate.

21-22. (canceled)

23. A combination comprising:
a door or window opening having an upper frame and a lower frame, and
an adjustable security apparatus for preventing entry, said apparatus comprising:
a plurality of posts;
a first end plate for fastening a first end of said adjustable apparatus to the upper frame of said opening; and
a second end plate for fastening a second end of said apparatus to the lower frame of said opening;
wherein said plurality of posts further comprise:
a first portion having a predetermined length; and
a second portion having a predetermined length;
wherein said first portion telescopically engages said second portion, and
wherein a length of said plurality of posts telescopically adjusts to correspond to a longitudinal dimension between said upper frame and said lower frame of said opening.

24. A combination comprising:
a door or window defining an opening and having an upper frame and a lower frame, and
modular adjustable security apparatus for protecting against undesired access, said modular adjustable apparatus having a plurality of modules, wherein each of said modules comprises:
a plurality of posts;
a first end plate for fastening a first end of said adjustable apparatus to the upper frame of said opening; and
a second end plate for fastening a second end of said apparatus to the lower frame of said opening;
wherein said plurality of posts further comprise:
a first portion having a predetermined length; and
a second portion having a predetermined length;
wherein said first portion telescopically engages said second portion, and
wherein a length of said plurality of posts telescopically adjusts to correspond to a longitudinal dimension between said upper frame and said lower frame of said opening.
